(19) United States
(12) Patent Application Publication
(10) Pub. No.: US 2010/0288204 A1
(43) Pub. Date: Nov. 18, 2010

(54) Vehicle pet restraint system

(75) Inventors: Richard Earl Costello, Clinton Township, MI (US); Michael Schindzielorz, Kernersville, NC (US); Joseph Wieczorek, Lake Orion, MI (US); Hirohisa Takada, Kanagawa Prefecture (JP)

Correspondence Address: FOLEY AND LARDNER LLP;SUITE 500, 3000 K STREET NW, WASHINGTON, DC, 20007, US

(73) Assignee: TK Holdings Inc.

(21) Appl. No.: 12/662,833

(22) Filed: May 5, 2010

Related U.S. Application Data
(60) Provisional application No. 61/213,153, filed on May 12, 2009.

(51) Int. Cl. A01K 31/07

(52) U.S. Cl. 119/453

(57) ABSTRACT

A carrier device for restraining an animal inside and outside of a motor vehicle. The carrier device includes a plurality of panels configured to form a hollow enclosure for housing the animal and a strap for connecting the enclosure to the motor vehicle. At least one of the panels includes a frame for supporting the panel in order to maintain the shape of the enclosure. The panels and the frame are configured to allow the enclosure to collapse so that the carrier can be folded. The strap includes fastening mechanisms at each end. A portion of the strap located between the two ends is connected to one of the panels of the enclosure so that during a sudden acceleration or deceleration of the motor vehicle, the animal is restrained within the enclosure and a force exerted on the enclosure is transferred to the motor vehicle.

### CROSS-REFERENCE TO RELATED PATENT APPLICATIONS

This application claims priority from Provisional Application U.S. Application 61/213,153, filed May 12, 2009, incorporated herein by reference in its entirety.

### BACKGROUND

The present application relates generally to the field of carrier devices for restraining an animal inside and outside of a motor vehicle. More specifically, the application relates to an improved carrier device which, in-vehicle, reduces potential injury to both the restrained animal and to vehicle occupants when the vehicle is subjected to a dynamic impact event; and, outside-vehicle, acts as a portable animal carrier device/kennel.

Carrier devices currently serve the primary purpose to restrain the movement of the animal while in-vehicle to limit distractions to the vehicle's driver (e.g., contacting the driver), which may arise from unrestricted animal movement. A secondary purpose of some carrier devices is to protect the interior of the vehicle from soilment by providing a surface that the animal is positioned on so that the animal does not contact the fabric of the interior.

It has been known to make a carrier device to be substantially hexahedral allowing ingress and egress of the animal through a door or zippered panel. Some systems have been constructed of quasi-rigid materials, such as injection molded polymers, having a steel grate door, commonly used for airport transportation of the animal. Other systems have been constructed of flexible materials, such as polymer mesh configurations, which may fold up for storage or for transporting the system without an animal. These systems typically are coupled to the seatbelt or to the seatback of the seat assembly and have several disadvantages, at least some of which are as follows. First, these systems are not configured to be structural and are unable to withstand the forces generated by a dynamic vehicle impact. The quasi-rigid configurations may shatter from impact from the inertial force generated by the animal and from the reaction forces from the harnesses coupling the system to the seat assembly. The flexible configurations may yield through the meshing or tear along non-structural seams joining adjacent panels. The flexible configurations may therefore create in-vehicle debris (e.g., metal grate door) as well as allow the animal, during a dynamic event, to gain kinetic energy, both of which could injure vehicle occupants. Second, not being structural, these systems upon failure to restrain the animal during a vehicle dynamic impact event, will fail to restrain the animal following the impact. This may create other issues, such as impeding emergency medical responders from providing medical attention to injured vehicle occupants.

It has been known to make a carrier device which includes a harness or vest type device that is positioned around the chest of the animal and further includes a tether strap coupled on one end to the vest or harness and coupled on the other end to the seat (e.g., seat belt webbing or seat back). These systems have several disadvantages, at least some of which are as follows. First, most of these systems are not configured to be structural and are unable to withstand the forces generated by a dynamic vehicle impact. The few harness type systems that purport to be structural only adequately restrain the animal if the harness is cinched up tight to the seat assembly, so that the animal has virtually no mobility while restrained. If the animal is allowed even small amounts of slack from these systems, then during a (forward) vehicle dynamic impact the tether and harness may not tear, but may allow the animal to displace toward a forward positioned occupant allowing enough displacement whereby the animal can contact the occupant or the seat of the occupant, potentially injuring the occupant and the animal. Second, these carrier devices also may not restrain the animal following an impact event, potentially impeding emergency medical responders from providing medical attention to injured vehicle occupants. Third, the carrier devices do not provide restraint to the animal outside of the vehicle unless the tether is held as if a leash.

It would be advantageous to construct a carrier device that is made from structural materials and configured to withstand forces that can be generated by the dynamic impact of a vehicle to another vehicle or to an obstacle to reduce potential injury to the animal and to the vehicle occupants during such incidents. It would also be advantageous to construct a carrier device that further restrains the animal following such an impact event, to allow occupants to receive medical attention without impediment from a potentially injured and disoriented animal. Also, it would be advantageous to construct a carrier device that may be removed from the vehicle and used as an animal carrier device or animal kennel device outside the vehicle. It would further be advantageous to construct a carrier device which prevents soilment of the fabric of the interior of the vehicle by including a fabric base that is easily removable for cleaning.

### SUMMARY

One embodiment relates to a carrier device for restraining an animal inside and outside of a motor vehicle. The carrier device includes a plurality of panels configured to form a hollow enclosure for housing the animal and a strap for connecting the enclosure to the motor vehicle. At least one of the panels includes a frame for supporting the panel in order to maintain the shape of the enclosure. The panels and the frame are configured to allow the enclosure to collapse so that the carrier can be folded. The strap includes fastening mechanisms at each end. A portion of the strap located between the two ends is connected to one of the panels of the enclosure so that during a sudden acceleration or deceleration of the motor vehicle, the animal is restrained within the enclosure and a force exerted on the enclosure is transferred to the motor vehicle.

It is to be understood that both the foregoing general description and the following detailed description are exemplary and explanatory only, and are not restrictive of the embodiments as claimed.

### BRIEF DESCRIPTION OF THE DRAWINGS

These and other features, aspects, and advantages of the present embodiments will become apparent from the following description, appended claims, and the accompanying exemplary embodiments shown in the drawings, which are briefly described below.

FIG. 1 is a perspective view of a motor vehicle.

FIG. 2 is a perspective view of an exemplary embodiment of a carrier device configured for use within a motor vehicle, such as the motor vehicle of FIG. 1.

FIG. 3 is a bottom view of the carrier device of FIG. 2 configured in the folded position.

FIG. 4 is a perspective view of the carrier device of FIG. 2 configured in the unfolded position.

FIG. 5 is a perspective view of the carrier device of FIG. 2 configured in the unfolded position.

FIG. 6 is a perspective view of the carrier device of FIG. 2 shown with an internal pet harness.

FIG. 7 is a perspective view of yet another exemplary embodiment of a carrier device configured for use within a motor vehicle, such as the motor vehicle of FIG. 1.

FIG. 8 is a perspective view of the carrier device of FIG. 7, configured with the access door in the open position.

FIG. 9 is a schematic view of the carrier device of FIG. 7 showing several straps used to secure the carrier device to a motor vehicle.

### DETAILED DESCRIPTION

The same or like reference numbers have been used throughout the drawings to refer to the same or like parts. Although the specification refers primarily to a pet restraint system, it should be understood that the subject matter herein is applicable to a carrier device for restraining an animal inside and outside of a motor vehicle in general.

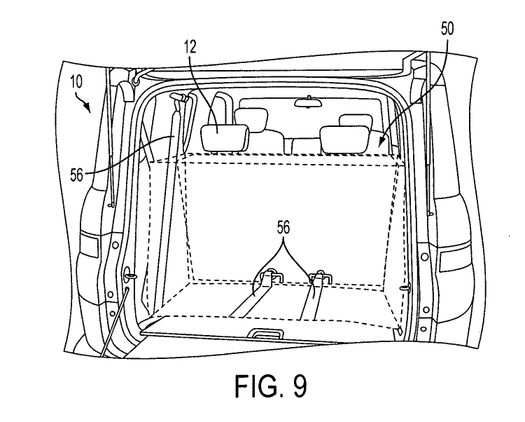

FIG. 1-9 illustrate a carrier device 20, 50, such as a pet restraint system 20, 50 for restraining an animal inside and outside of a motor vehicle 10. As shown in FIG. 1, the motor vehicle 10 may be a sport utility vehicle (SUV). Other motor vehicles (e.g., sedan, truck, van, cross-over vehicle, etc.) as well as other moving vehicles that offer coupling to seat assemblies through the below described attachment methods may also be used to include the pet restraint system 20, 50. The pet restraint system 20, 50 may be used outside of a vehicle 10 for either convenient carrying or transporting of the animal, or may be used as a kennel to restrict the mobility of the animal to the confines of the interior of the animal restraint system 20, 50. The animal may be any suitable animal, for example a pet.

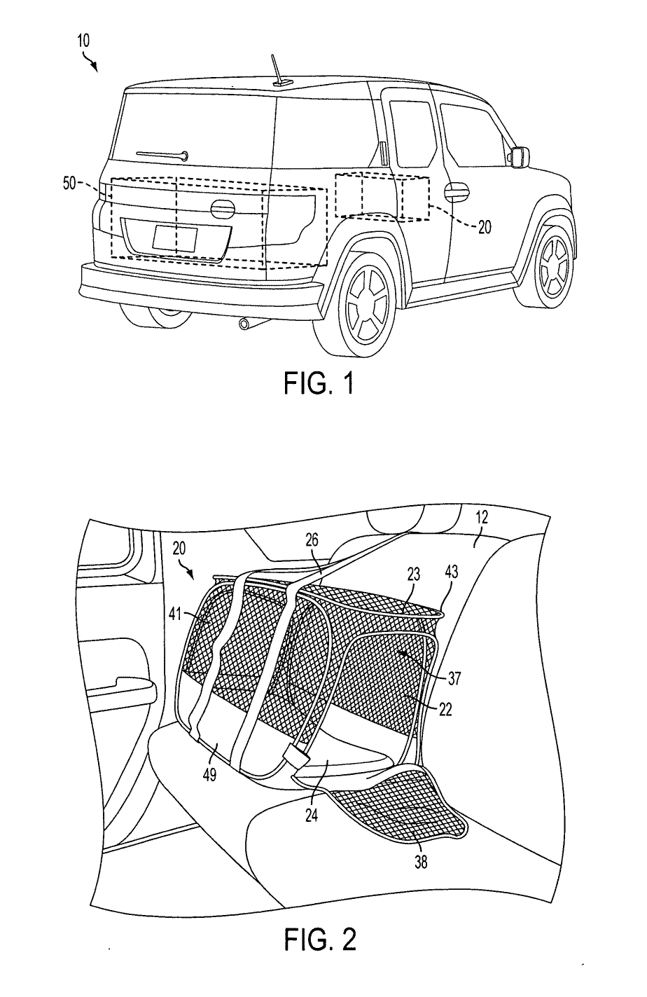

As shown in FIG. 2-6, the pet restraint system 20 may include a plurality of panels 22 configured to form a hollow enclosure 37 for housing the pet and a strap 26 for connecting the enclosure 37 to the vehicle 10. The carrier device 20 is configured to be placed on a seat assembly 12 (e.g., a passenger seat, a back seat or a second row seat) of the vehicle 10.

The pet restraint system 20 may include any suitable amount of panels 22. For example, the pet restraint system 20 may include six panels 22 that form an enclosure 37 having a substantially hexahedral shaped shell. Other pet restraint systems 20 may have any number of panels 22 which may form an enclosure 37 having any suitable useful shape (e.g., an octahedron, hexahedral or another polyhedron).

At least one of the panels 22 may include a frame 23 for supporting the panel 22 in order to maintain the shape of the enclosure 37. The panel 22 and the frame 23 are configured to allow the enclosure 37 to collapse so that the pet restraint system 20 can be folded.

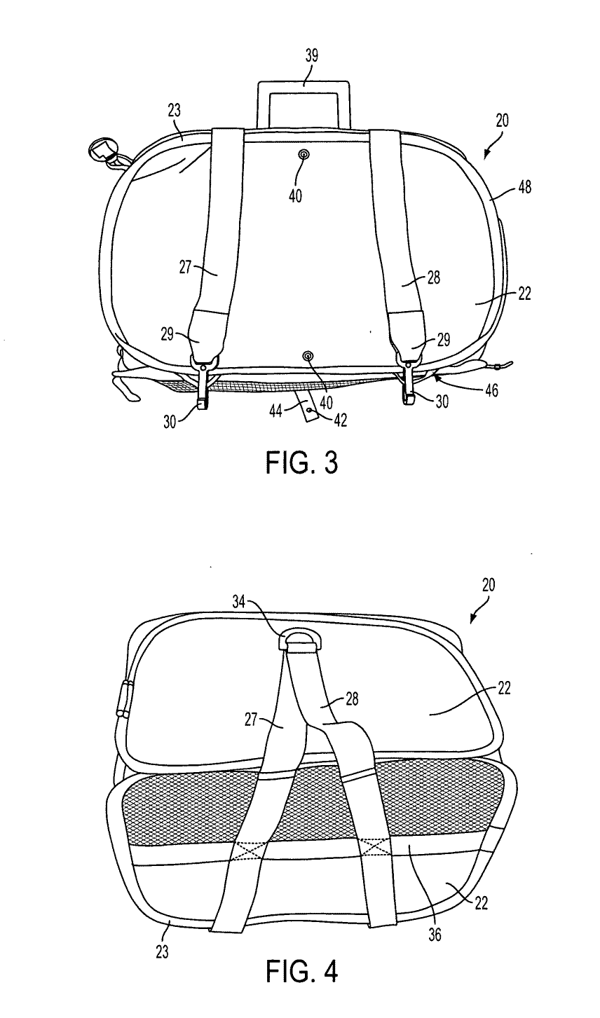

The pet restraint system 20 may be configured to be transformable from being folded or a folded configuration(e.g., storage configuration, collapsed configuration, etc.) to a pet restraint configuration (e.g., or use configuration, expanded configuration, unfolded configuration, etc.). The unfolded pet restraint system 20 confines the pet with the panels 22 that form the enclosure 37 (e.g., hexahedral shaped shell, octahedron, or another polyhedron) but offers an enclosed center portion for housing the pet, inside of which the pet is free to move about. To accommodate different sized pets (e.g., cats, small dogs, medium sized dogs, etc.) the pet restraint system 20 may be constructed in a variety of sizes to provide adequate protection for the pet but still offer enough room in the enclosed center portion to allow the pet to move around. The ability of the pet restraint system 20 to be folded, also allows for the pet restraint system 20 to be a more convenient shape and size when not housing a pet, such as shown in FIG. 3.

Each panel 22 may include a pocket or sleeve 48, such as shown in FIG. 3, around all or part of the periphery 43 of each panel 22. The pocket 48 may be formed by folding and then coupling (e.g., stitching) the end of the panel 22 over on itself.

The frame 23 may include a plurality of frame members. The frame members may be integrated into one of the panels along the periphery 43 of each panel 22. The frame members may be integrated because the pocket 48 may house the frame members. The frame members are preferably relatively flexible, so that the frame members are able to be folded onto each other to form a relatively thin folded pet restraint system 20. The frame members may be, for example, in the form of a rod or wire support. For example, the frame members may be pivotal components, as described in U.S. Pat. No. 5,915,723, which is incorporated herein by reference in its entirety or slat-members, as described in U.S. Pat. No. 4,646,802, which is incorporated herein by reference in its entirety.

If the frame members are in the form of a wire support, the wire support may be formed from a spring steel or other useful material. The wire support maintains the shape of the pet restraint system 20 when it is unfolded. The wire support may have a relatively small diameter or thickness to provide shape but still be flexible to allow the pet restraint system 20 to collapse into the folded configuration. If the frame members are in the form of a rod, the rod may be formed from any useful material. The rod maintains the shape of the pet restraint system 20 when it is unfolded. The rod may have a relatively small diameter or thickness to provide shape but still be flexible to allow the pet restraint system 20 to collapse into a folded configuration.

Additionally, each panel 22 may include a porous portion 41 or porous material 41 or multiple porous portions 41 and/or a non-porous material 49 (FIG. 2). The porous material 41 may be made from a thin, flexible, porous structural fabric material (e.g., a mesh fabric). A mesh fabric or other relatively open material provides breathability and visibility to the pet when enclosed within the pet restraint system 20 and allows a passenger to observe and monitor the pet enclosed within the pet restraint system 20. The non-porous material 49 may be made from a thin flexible structural fabric material (e.g., a ballistic nylon). The porous material 41 and the non-porous material 49 may be supported on at least one side by the frame 23.

The pet restraint system 20 may also include a pad 24 located within the enclosure 37 and adjacent to one of the panels 22. The pad 24 of the pet restraint system 20 may be made from any fabric and may form a shell that encloses a cushion. The pad 24 may be placed on a top surface of the bottom panel 22 within the pet restraint system 20 to provide improved comfort to the pet when inside the pet restraint system 20. The pad 24 may additionally include an absorbent layer or material to absorb liquids and protect the upholstery of the seat 12 on which the pet restraint system 20 is placed. The pad 24 may also include a feature to allow for detachable coupling to one or more panel 22 (e.g., a hook and loop fastener, snaps, buttons, zippers etc.). The pad 24 may be removable from the pet restraint system 20 for cleaning or other purposes of utility.

The strap 26 may be attached to the external surfaces of at least one panel 22 by using a structural coupling method, such as stitching. The strap 26 may be made from traditional seatbelt webbing (e.g., a high strength nylon or polyester) and may be coupled to the pet restraint system with a first portion 27 and a second portion 28 that are arranged in a substantially V-shape configuration. The two ends 29 of the strap 26 are separated by a predetermined distance for ease of coupling to a seat assembly 12. The ends 29 may be separated by a distance that is approximately equal to the distance between the lower anchors according to the ISOFIX standard.

Each end 29 of the strap 26 includes a fastening mechanism 30 or first fastening mechanism 30 which is configured to attach or couple to one of the ISOFIX wires or attachment points of a seat assembly 12, which are typically positioned in the split line of the seat assembly 12 (i.e., between the seat cushion and the seat back). The fastening mechanism 30 may be one of a variety of mechanisms that suitably couple the end 29 of the strap 26 to the ISOFIX anchor point. For example, the fastening mechanism 30 may be a hook (e.g., an open hook, a clip, hook with a spring-loaded closure, etc.) that is configured to engage a rigid U-shaped wire anchor located in the vehicle 10. The fastening mechanism 30 may also be an alligator-like clip with a pair of opposing, spring-loaded jaws. Additionally, the fastening mechanism 30 may be an anchor ring and be configured to engage a hook or clip coupled to the seat assembly 12.

Another fastening mechanism 34 or anchor 34 may be provided on the end of the strap 26 between the first portion 27 and the second portion 28 of the strap 26 and opposite the first fastening mechanisms 30, near the base of the V-shape of the strap 26. The anchor 34 may be made of steel or some other material with a sufficient strength to transfer the loads and may be substantially D-shaped. The anchor 34 may be fixedly coupled to the strap 26 or may be slideably coupled to the strap 26. The anchor 34 may be configured to attach or couple to the ISOFIX anchor or tether bracket of the seat assembly 12, which is typically positioned on the rear surface of the seatback 12.

The strap 26 may be coupled to one or more panel 22 by structural methods (e.g., seatbelt stitching). The pet restraint system 20 may include more than one strap 26 (not shown), such as two straps 26 that are substantially parallel, each having one end including a fastening mechanism 30, whereby the other end of both straps 26 are coupled to the anchor 34.

The pet restraint system 20 may also include one or more support straps 36, as shown in FIG. 4, for strengthening at least one of the panels 22. A support strap 36 is made out of traditional seatbelt webbing (e.g., a high strength nylon) and may be coupled to one or more panels 22 to provide improved strength to the pet restraint system 20. A support strap 36 may also be coupled to the panel 22 and the strap 26 that includes the fastening mechanism 34 and fastening mechanisms 30, by for example stitching, to provide stability and strength to the pet restraint system 20 when subjected to loading. A support strap 36 may also provide a structural transition between the non-porous material 49 (e.g. relatively solid portion of a panel 22 located near the periphery 43 of the panel 22) and the porous-material 41 (e.g. mesh portion of the panel 22).

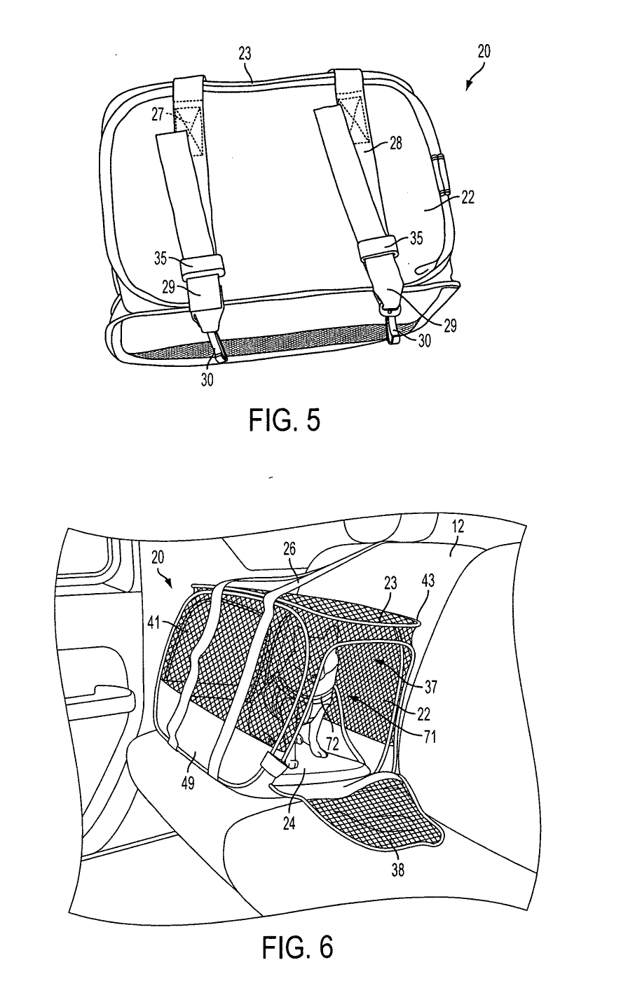

The carrier device 20 may include an adjusting mechanism 35 or an adjustable feature 35, as shown in FIG. 5, coupled near one of the two ends 29 of the strap 26 and configured to shorten or lengthen the strap 26. The adjustable feature 35 may also be coupled near each end 29 of the strap 26. The adjustable feature 35 allows for adjustment of the pet restraint system 20 relative to the seat assembly 12 that the pet restraint system 20 is to be coupled to by allowing shortening or lengthening of the two portions 27 and 28 of the strap 26. The adjustable feature 35 provides for adjustment of the pet restraint system 20 so that it can accommodate variation between seat assemblies.

The pet restraint system 20 may also include a door 38 or access feature 38 included in one of the panels 22 and configured to allow the animal to enter and exit the carrier device 20. The access door 38 may include a zipper or other device to allow ingress and egress of the pet, yet restrains the pet inside the pet restraint system 20 when the access door 38 is closed. Referring to FIG. 2, the access door 38 may be formed on one of the side panels 22 of the pet restraint system 20. Alternatively, the pet restraint system 20 may include any number of access doors 38, and/or may include access doors 38 which are formed between more than one panel 22.

Additionally, the pet restraint system 20 may also include a handle 39 or carrying strap 39, as shown in FIG. 3, configured to extend from one of the panels 22. The handle 39 or carrying strap provides for improved utility for transporting the pet restraint system 20 both inside and outside the vehicle 10. The handle 39 may be a molded polymer handle that is coupled to one panel 22 of the pet restraint system 20. Alternatively, for example, the handle 39 may be made from a nylon mesh and configured to be a strap, which may be coupled (e.g., stitched) to one of the panels 22 of the pet restraint system 20. The handle 39 provides for ergonomically improved transporting of the pet when confined to the inside of the pet restraint system 20.

The pet restraint system 20 may further include a locking mechanism 40, 42, 44 or coupling feature 40, 42, 44 for preventing the carrier device 20 from unfolding when the carrier device 20 is folded. The coupling feature 40, 42, 44 locks and maintains the pet restraint system 20 in the folded configuration. The coupling feature 40, 42, 44 may, for example as shown in FIG. 3, be a snap having two portions which are detachably coupled to one another. The first snap portion 40 or receiving device 40 may be coupled directly to one of the panels 22 of the pet restraint system 20, and the second snap portion 42 or engaging device 42 may be coupled to a tying feature or a locking member 44, which may be a small flexible strap that extends from one of the panels 22. The second snap portion 42 is configured to couple to the snap portion 40. Other coupling features may also be used to maintain the folded configuration of the pet restraint system 20 (e.g., buttons, hook and loop fasteners, etc.).

The pet restraint system 20 may further include pockets 46 to hold the fastening mechanisms 30 when the pet restraint vehicle 20 is used outside of the vehicle 10. Any suitable pocket 46 capable of holding the fastening mechanisms 30 may be included. The pocket 46, for example, may be formed by folding a portion of a panel 22 over and onto itself and stitching a portion of the overlapping surfaces and leaving an opening to insert the fastening device 30 into. Alternatively, for example, the pocket 46 may be formed by coupling an additional portion of fabric to an existing panel 22 through stitching or another method. The pockets 46 may be constructed to include a zipper or another folded portion to help retain the fastening mechanisms 30 inside the pocket 46.

The pet restraint system 20 may also include, as for example shown in FIG. 6, a harness 71 anchored to the pet restraint system 20 and included within the enclosure 37. The harness 71 may include a plurality of straps 72 coupled together by any suitable mechanism (e.g. stitching, adhesive). The harness 71 helps to further restrain the pet. The harness 71 may be any suitable harness. For example, the harness 71 may be similar to the harness as described in U.S. Pat. No. 4,676,198, which is incorporated herein by reference in its entirety or to the vest described in U.S. Pat. No. 6,637,377, which is incorporated herein by reference in its entirety. The harness 71 may be anchored to any part of the pet restraint system 20 or to the inside of the vehicle 10. For example, a strap 72 of the harness 71 may extend through an opening in the pet restraint system 20 and be anchored to the vehicle 10 at a hook or an ISOFIX wire of the seat assembly 12. Alternatively, for example, a strap 72 of the internal harness 71 may be anchored to hooks or clips coupled to and extending from an inside of the enclosure 37.

As shown best in FIG. 2, the pet restraint system 20 may be positioned on the seat assembly 12 of a vehicle 10, so that each fastening mechanism 30, 34 is coupled to one ISOFIX wire of the seat assembly 12. The fastening mechanism (e.g. anchor or D-ring) 34 of the pet restraint system 20 may further be coupled to the ISOFIX tether bracket of the seat assembly 12. A pet may be placed inside the unfolded pet restraint system 20 coupled to the seat assembly 12 to limit the movement of the pet to the confines of the interior space of the pet restraint system 20. The pet having mobility inside the pet restraint system 20 offers comfort to the pet, yet the restraint of movement by the pet restraint system 20 limits the distractions created by the pet to the driver of the vehicle 10. A pet having unrestrained movement inside the vehicle 10 may create driver distractions (e.g., contacting the driver, protruding through the window), which could lead to an accident or incident, such as a vehicle dynamic impact event.

During a vehicle dynamic impact involving a pet inside a pet restraint system 20, the mass of the pet being decelerated with the vehicle 10 creates a force substantially in the forward direction (for a frontal impact) or substantially in the rearward direction (for a rearward impact). The forward force may displace the pet toward the front of the vehicle 10 and away from the seat assembly 12 to which the pet restraint system 20 is coupled, causing the pet to impact the front panel 22 of the pet restraint system 20. The frame member such as a wire or rod around the periphery 43 of the panel 22 adds structural integrity to the panel 22, retaining the pet and restraining the displacement of the pet to the interior volume of the pet restraint system 20. The forward force of the pet into the pet restraint system 20 puts the strap 26 of the pet restraint system 20 in tension between the fastening mechanisms 30 and the fastening mechanism 34, transferring the loads into the seat assembly 12 and thus limiting the displacement of the pet restraint system 20 to the displacement of the seat assembly 12 plus any stretch of the strap 26. A rearward force in a rear impact may displace the pet and pet restraint system 20 toward the seat assembly 12 the pet restraint system 20 is coupled to, thereby loading directly into the seat 12 by distributing the load across the surface of the seat assembly 12.

Thus the pet restraint system 20 reduces potential injury to the pet by limiting the displacement of the pet and reducing the likelihood the pet contacts other vehicle components which could create impact and force concentrations on the pet. Additionally, the pet restraint system 20 reduces injury to the pet by distributing the loading from the dynamic event over a relative large portion of the pet from contacting one or more than one panel 22 of the pet restraint system 20. The pet restraint system 20 also reduces the potential injury to vehicle occupants by restraining the pet and reducing the likelihood that the pet will contact the occupant or the seat of the occupant during the dynamic vehicle event.

It should be noted that a pet restraint system 20 as described in this application also reduces the potential of the pet to be ejected from the vehicle 10 during a dynamic impact event, including a rollover event of the vehicle 10. During impact events of the vehicle 10 which induce the vehicle 10 to roll over, forces likely can induce the unrestrained pet to displace in substantially upward and outward directions, creating a situation for ejection from the vehicle 10. By confining the pet to the interior of the pet restraint system 20, the likelihood of ejection of the pet is reduced. The pet restraint system 20 also retains the enclosed pet following a dynamic impact event, which makes it easier and safer for emergency response personnel to administer first aid to injured vehicle occupants.

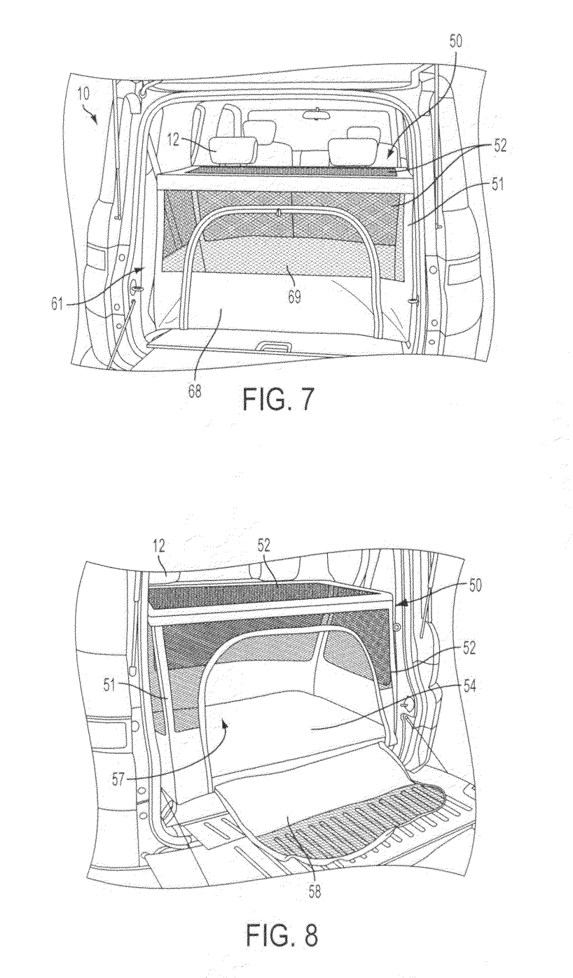

Referring to FIGS. 7-9, a pet restraint system 50 may include a plurality of panels 52 configured to form a hollow enclosure 57 for housing the animal and a strap 56 for connecting the enclosure 57 to the vehicle 10 similar to the pet restraint system shown in FIG. 2-6. The pet restraint system 50 may also include a support frame 51 or frame 51, a pad 54, an access feature 58 (or a door), and an internal harness (not shown) similar to the pet restraint system shown in FIG. 2-6. Unlike the pet restraint system shown in FIG. 2-6, however, the pet restraint system 50 is configured to be placed in the cargo area 61 of the vehicle 10.

Unlike the pet restraint system shown in FIG. 2-6, the support frame 51 may be made of a plurality of rods that are detachably coupled together to form a lightweight flexible structure which may be substantially hexahedral shaped, or form some other useful shape. Alternatively, the rods may be made from a composite material, such as carbon fiber, and may have a small diameter relative to length. Or, the rods may be made from any other material that is high strength and flexible. The rods may have a solid diameter or may be hollow. The support frame 51 provides structural support to the pet restraint system 50, maintaining the shape of the system 50 when configured to house a pet within the system. The rods of the support frame 51 being flexible allow the system 50 to be configured into a folded or stored position for improved storage or mobility.

Similar to the panels shown in FIG. 2-6, the plurality of panels 52 may include a porous material 69 or multiple porous portions 69 and/or a non-porous material 68 (FIG. 7). The porous material 69 provides breathability and visibility to the pet when enclosed within the pet restraint system 50 and allows a passenger to observe and monitor the pet enclosed within the pet restraint system 50.

The panels 52 may be coupled together to form a shell that fits over the outside of the support frame 51 and may have features that couple the panel 52 to a portion of the support frame 51 (such as sleeves or straps sewn or otherwise formed and coupled to the panel 52). Alternatively, each panel 52 may be coupled to a specific portion of the support frame 51 and then may be coupled to other adjacent panels 52, which are coupled to other specific portions of the support frame 51. The unfolded pet restraint system 50 offers an enclosed center portion inside the coupled support frame 51 and shell of panels 52 for housing the pet, inside which the pet is free to move about, but is confined by the panels 52 that form the hexahedral (or other useful) shape shell. The unfolded pet restraint system 50 may also be removed from the vehicle 10 and used as a carrier for the pet, such as taking the pet to the veterinarian, or may be used as a kennel. The folded pet restraint system 50 offers ergonomic and easy transportation of the system and also offers reduced volume for efficient storage.

The pad 54 may be configured similar to the pet restraint system shown in FIG. 2-6. The pad 54 is removable to provide easy cleaning of the pad 54 and the interior of the panels 52 of the pet restraint system 50. The pad 54 provides a softer surface for the pet to stand or lay on compared to the surface of the cargo area of the vehicle, which may be, for example, a relatively hard metal or polymer surface.

One or more straps 56 may be provided to couple the pet restraint system 50 to the interior of the vehicle 10. The strap 56 may, for example, be attached to the external surfaces of at least one panel 52 by using a structural coupling method, such as stitching (FIG. 7). The strap 56 may be made from traditional seatbelt webbing (e.g., a high strength nylon). Alternatively, the pet restraint system 50 may include multiple straps 56 that are coupled to the panels 52 of the pet restraint system 50 at various places (not shown). As another example, a single strap 56 may be configured to have multiple ends (e.g., two, three, four, etc.) (not shown). The straps 56 may include anchors or fastening mechanisms which allow the base or bottom of the pet restraint system 50 to be coupled to the floor or other interior components of the vehicle 10.

The strap 56 may be coupled to the child seat anchor on the back of the seatback 12, and/or may be routed up over the seatback 12 and coupled to the headrest of the seat 12. The straps 56 may also be coupled to structural tie downs located in the rear storage compartment (e.g., with anchors or fastening mechanisms), as shown according to one exemplary embodiment in FIG. 9.

The access door 58 or door 58 may be configured similar to the pet restraint system shown in FIG. 2-6 and may be incorporated on any of the panels 52 of the pet restraint system 50. The access door 58 may, for example, be configured on the rear facing panel 52, which allows easy access to the pet restraint system 50 when the tailgate or rear hatch of the vehicle 10 is open.

The pet restraint system 50 may be configured to be positioned in the rear storage compartment of the vehicle 10, such as behind the rear-most seat row 12 of a SUV or a wagon type vehicle. Positioning the pet restraint system 50 in the rear storage compartment of the vehicle 10, allows for storage and transport of larger pets, or provides increased room to smaller pets for improved comfort.

The pet restraint system 50 provides improved safety to the driver of the vehicle 10 by reducing the distractions from the pet moving around inside the vehicle 10. The pet restraint system 50 also provides improved safety to the pet by reducing the potential for injury by reducing the likelihood of impact of the pet with other components within the vehicle interior, with vehicle occupants, and with flying debris that may be generated from a vehicle impact. Additionally, the pet restraint system 50 reduces the likelihood that the pet may be ejected from the vehicle 10 during a dynamic impact event.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the pet restraint systems as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present embodiments.

What is claimed is:

1. A carrier device for restraining an animal inside and outside of a motor vehicle, the device comprising:
a plurality of panels configured to form a hollow enclosure for housing the animal;
wherein at least one of the panels includes a frame for supporting the panel in order to maintain the shape of the enclosure, wherein the panels and the frame are configured to allow the enclosure to collapse so that the carrier can be folded;
a strap for connecting the enclosure to the motor vehicle; wherein the strap includes fastening mechanisms at each end, and
wherein a portion of the strap located between the two ends is connected to one of the panels of the enclosure so that during a sudden acceleration or deceleration of the motor vehicle, the animal is restrained within the enclosure and a force exerted on the enclosure is transferred to the motor vehicle.

2. The carrier device of claim 1, wherein the frame includes a plurality of frame members and wherein each frame member is integrated into of one of the panels along the periphery of the panel.

3. The carrier device of claim 1, wherein at least one of the panels includes a porous material and a non-porous material and wherein the porous material is configured to permit the flow of air into and out of the enclosure and to permit visibility of the animal located in the enclosure.

4. The carrier device of claim 3, wherein the porous material includes mesh fabric and the non-porous material includes nylon or polyester.

5. The carrier device of claim 1, wherein a shape of the enclosure is selected from the group consisting of hexahedral, octahedron, and polyhedron.

6. The carrier device of claim 2, wherein each of the frame members comprises a wire or a rod.

7. The carrier device of claim 1, wherein one of the fastening mechanisms comprises a clip or a hook configured to connect to an anchor ring located in the motor vehicle.

8. The carrier device of claim 1, wherein one of the fastening mechanisms comprises an anchor ring configured to connect to a clip or a hook located in the motor vehicle.

9. The carrier device of claim 1, wherein the strap further includes an anchor ring connected to the strap at a location between the ends of the strap.

10. The carrier device of claim 9, wherein the anchor ring is connected to the strap between the portions of the strap.

11. The carrier device of claim 1, further comprising a door included in one of the panels and configured to allow the animal to enter and exit the carrier.

12. The carrier device of claim 1, further comprising a pad located in the enclosure and adjacent to one of the panels.

13. The carrier device of claim 12, wherein the pad includes an opening configured to receive a cushion.

14. The carrier device of claim 12, wherein the pad is configured to detachably couple to one of the panels.

15. The carrier device of claim 1, further comprising a support strap for strengthening at least one of the panels, wherein the support strap is connected to one of the panels or is connected to one of the panels and the portion of the strap.

16. The carrier device of claim 1, further comprising a handle configured to extend from one of the panels.

17. The carrier device of claim 1, wherein one of the panels is configured to store the fastener mechanisms.

18. The carrier device of claim 1, further comprising an adjusting mechanism coupled near one of the two ends of the strap and configured to shorten or lengthen the strap.

19. The carrier of claim 1, further comprising a locking mechanism for preventing the carrier from unfolding, wherein the locking mechanism includes a locking member extending from one of the panels and a receiving device coupled to one of the panels, wherein the locking member includes an engaging device configured to couple to the receiving device.
